(19) United States
(12) Patent Application Publication
(10) Pub. No.: US 2003/0096569 A1
(43) Pub. Date: May 22, 2003

(54) Fish and game cleaning table apparatus and system

(76) Inventor: Charles Britton, Pompano Beach, FL (US)

Correspondence Address: David P. Lhota, Stearns Weaver Miller, Suite 1900, 200 East Broward Boulevard, Fort Lauderdale, FL, 33301, US

(21) Appl. No.: 10/251,369

(22) Filed: Sep. 20, 2002

Related U.S. Application Data
(60) Provisional application No. 60/334,044, filed on Nov. 21, 2001.

(51) Int. Cl. A22C 25/06; A22C 18/00; A22C 21/00

(52) U.S. Cl. 452/194

(57) ABSTRACT

A fish and game cleaning and filleting table comprises a table top having a front edge, back edge and opposing side edges, wherein the back edge is lower than the front edge, an adjustable spraying assembly that pivots in relation to the table top, removable side plates, a vented back plate, gaps defined between the back plate and side plates, tapered legs and a base adapted for mounting the table to a flat surface. The base may also be adapted for mounting the table in a boat or truck.

### CROSS REFERENCE TO RELATED APPLICATIONS

This application claims the benefit of U.S. provisional patent application Serial No. 60/334,044, filed Nov. 21, 2001.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to an apparatus for filleting and cleaning fish and game, and more particularly to a free-standing fish cleaning table that may be placed on a dock or in a boat and having a structure for rinsing and draining.

2. Description of the Background Art

Following a fishing or hunting excursion, the fish and game caught are filleted and/or cleaned and thus require a place for holding and cleaning the fish and game. This is typically done dockside, boat-side or truck-side. Some fishing docks occasionally provide tables for use in cleaning fish, but they are not practical and have certain shortcomings. For instance, traditional tables have no way to keep fish on the table, no mechanism for rinsing the fish and table (other than a conventional hose) and/or no structure for draining water. As a result, cleaning and filleting fish dockside or boatside is cumbersome and troublesome. The prior art also fails to provide a table that is adapted for cleaning game. A fish and game-cleaning table that contains the catch on the table provides a mechanism for rinsing and includes structure for draining would be well received. A table that facilitates cleaning fish or game from a boat or truck bed could provide additional advantages that would be welcomed by fishermen and hunters. However, there are no known tables adapted for secured mounting to a boat or truck bed for cleaning game and/or fish. Accordingly, a fish and game-cleaning table that is adapted for mounting and use on a boat or truck bed would also be welcomed. Consequently there exists a need for a fish-cleaning table that solves the foregoing.

There exist in the prior art various tables for filleting and cleaning fish and game. However, none of these address or solve the above noted problems. For instance, U.S. Pat. No. 4,229,858 discloses a boat mountable fish cleaning tray comprising sides which define a drainage opening between two opposing ends, a cutting board attached to the tray, and legs releasably mounted to the tray. U.S. Pat. No. 4,454,628 discloses a fish cleaning table attachable to a sink faucet wherein the table comprises a rectangular vacuum molded body, a series of slats running lengthwise over the body supported by cross members which rest on notches in the body, hooked shaped legs which fold outward from the body and a water spraying system. U.S. Pat. No. 5,860,367 discloses a portable table for cleaning fish and other game, having a one piece molded work tray mounted on foldable legs, wherein the tray includes a plurality of recesses, bowls and openings.

Although several references were found for fish cleaning tables, none of the references found disclose a free-standing or boat-mountable table comprising a rinsing and drainage system as contemplated by the instant invention. Therefore, there exists a need for a free-standing or boat mountable table for filleting and cleaning fish and game that allows for convenient rinsing and drainage.

### BRIEF SUMMARY OF THE INVENTION

In accordance with the foregoing, it is a primary object of the instant invention to provide a table specifically designed for filleting and cleaning fish or game on sight.

It is another object of the instant invention to provide a fish and/or game-cleaning table that stands independently and sturdily with, minimal obstruction to a user's legs.

It is still another object of the instant invention to provide a cleaning table that prevents fish or game from falling off and that has the ability to handle large fish and game.

It is a further object of the instant invention to provide a water-spraying device that can conveniently rinse fish, game and/or the table without having to maneuver a hose.

It is a still further object of the instant invention to provide a means for water and debris to exit the table away from the user when it is rinsed.

In light of these and other objects, the instant invention generally comprises a fish or game cleaning table comprising a forward tilted or declinable table top assembly for simultaneously dumping water and debris from the table top while cleaning fish and game, back retaining panels for containing fish and game and having apertures for passing water and debris, removable side retaining panels and adjustable spraying assembly. The retaining panels keep fish and game from sliding off the table while allowing water to run off the table top and away from the user. The table top assembly preferably comprises a frame and slidably removable table top or platform comprising a material or materials that are durable, water safe and facilitate cutting, such as acrylic resins, high-density polyethylene and Corian®. The table top is supported by leg members that preferably taper inward toward at least one base that is mountable to the floor or a dock in a position that provides ample leg clearance. In an alternative embodiment the legs may be adapted for secure placement in a boat's fishing rod holders or a truck beds post holders in a manner that tilts the tap top downward away from its user as disclosed in the preferred embodiment. The adjustable spraying assembly comprises a U-shaped, perforated hollow rod pivotally attached to the table, hose receiving adapter and on/off valve. Water enters the rod when the valve is opened and exits through the perforations to spray the table. The rod pivots to direct the water and facilitate full coverage of the table top.

In accordance with these and other objects that will become apparent hereinafter, the instant invention will now be described with particular reference to the accompanying drawings.

### BRIEF DESCRIPTION OF THE SEVERAL VIEWS OF THE DRAWINGS

FIG. 1 is a front perspective view of the preferred embodiment of the instant invention.

FIG. 2 is a front elevational view of the preferred embodiment of the instant invention.

FIG. 3 is a left side elevational view of the preferred embodiment of the instant invention, illustrating an optional peg depending from the base.

FIG. 4 is a rear elevational view of the preferred embodiment of the instant invention.

FIG. 5 is a right side elevational view of the preferred embodiment of the instant invention.

FIG. 6 is a front perspective view of a first alternative embodiment of the leg portion of the instant invention and illustrates the table top partially removed.

FIG. 7 is a front elevational view of a second alternative embodiment of the instant invention, adapted for installation in a boat or truck bed.

FIG. 8 is a left side elevational view of the second alternative embodiment of the instant invention.

FIG. 9 is a bottom view of the table top frame of the preferred embodiment of the instant invention.

FIG. 10 is a bottom view of the table top illustrating the alternative base of the instant invention.

FIG. 11 is an elevational view of the back retaining panel in accordance with the preferred embodiment of the instant invention.

FIG. 12 is an elevational view of a side retaining panel in accordance with the preferred embodiment of the instant invention.

FIG. 13 is an end view of a side retaining panel illustrating its table top retaining tabs in accordance with the preferred embodiment of the instant invention.

FIG. 14 is a side elevational view of an alternative base having a mounting post for mounting the table in a boat, truck bed or any surface having a sleeve in accordance with an alternative embodiment of the instant invention.

FIGS. 15A-C are elevational views of the adjustable spraying assembly in accordance with the preferred embodiment of the instant invention.

FIG. 16 is a bottom view of an alternative embodiment of the table top frame and mounting assembly of the instant invention adapted for mounting the table in a boat, truck or any surface having sleeves.

FIG. 17A is a side elevational view of a table mounting assembly for mounting the table of the alternative embodiment of the instant invention in a fishing rod holder on a boat or a sleeve provided in the bed of a truck or other surface.

FIG. 17B is a side elevational view of an embodiment of the table mounting assembly for mounting the table of the alternative embodiment of the instant invention in a fishing rod holder on a boat or a sleeve provided in the bed of a truck or other surface that is positioned at a first angle.

FIG. 17C is a side elevational view of an embodiment of the table mounting assembly for mounting the table of the alternative embodiment of the instant invention in a fishing rod holder on a boat or a sleeve provided in the bed of a truck or other surface that is positioned at a second angle.

### DETAILED DESCRIPTION OF THE INVENTION

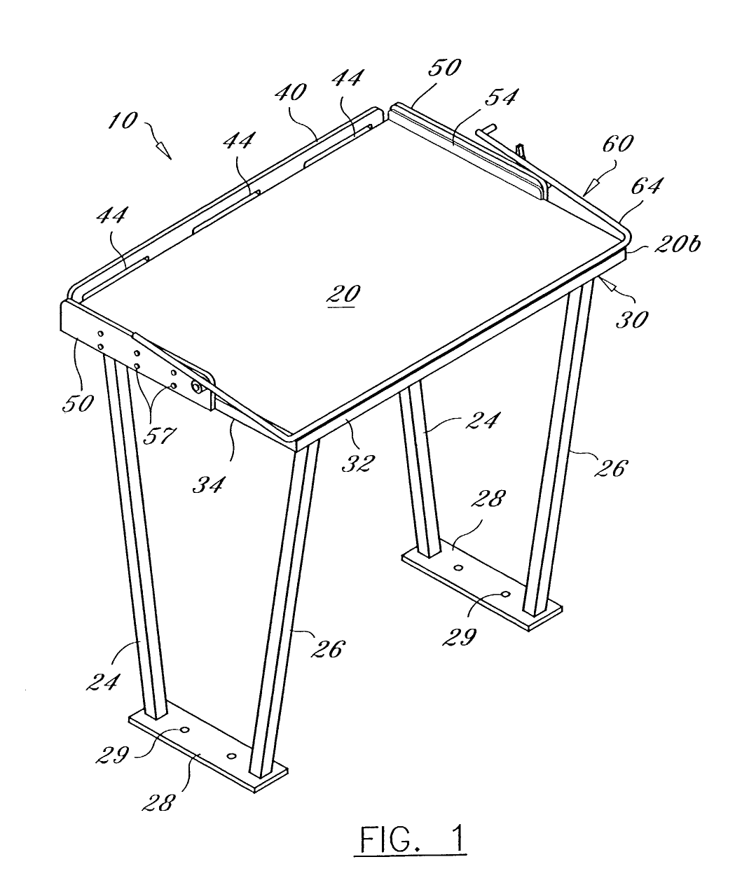

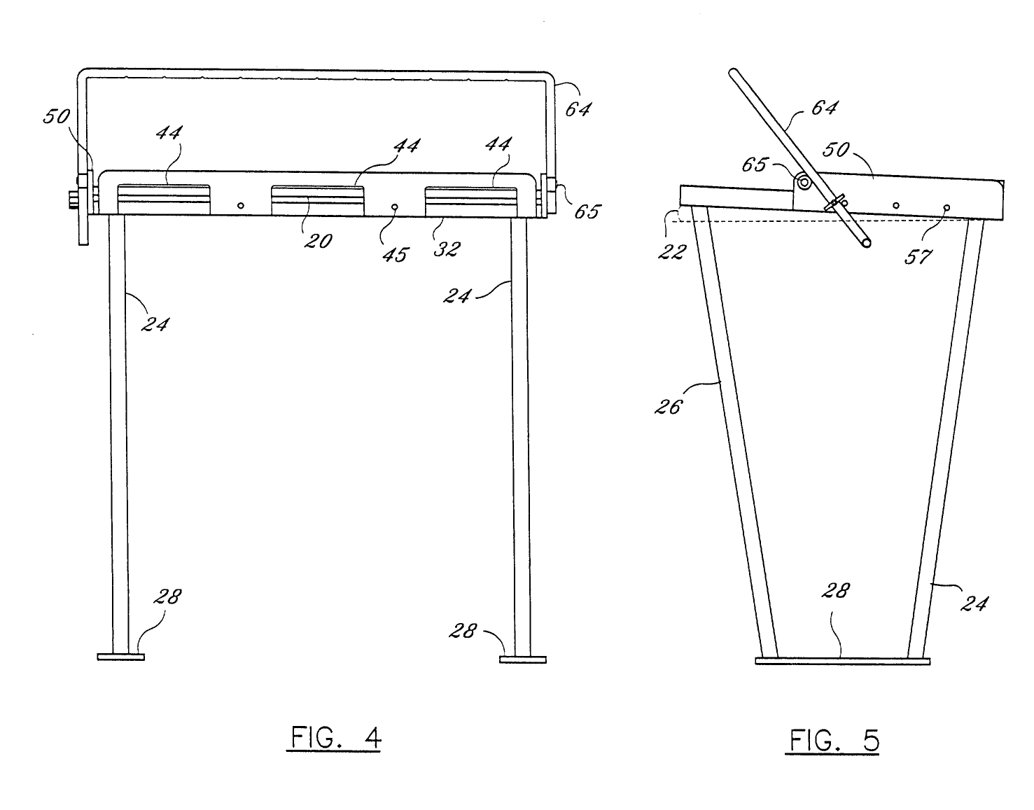

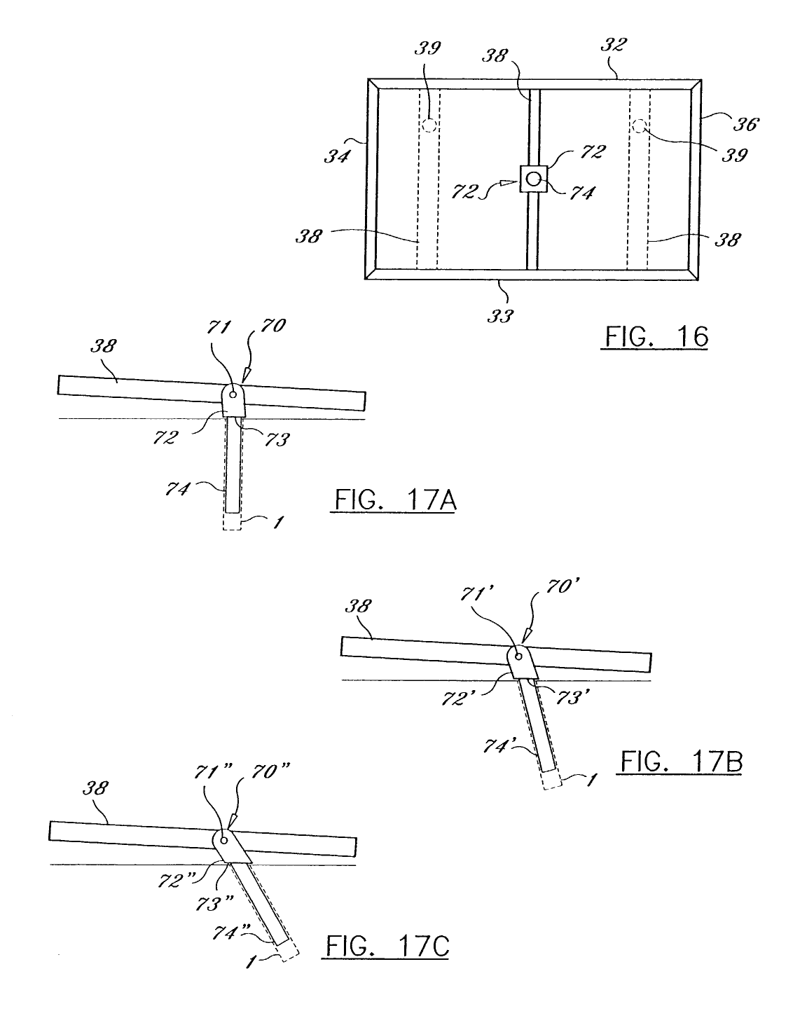

With reference to the drawings, FIGS. 1-17C depict the preferred and alternative embodiments of the instant invention, which is generally characterized as a cleaning table and/or by numeric character 10. With reference to FIGS. 1-6, the cleaning table 10 preferably comprises a downward and/or rearward tilting table top assembly 20-30, side panels 50, at least one vented back panel 40 and an adjustable spraying assembly 60. The table top assembly comprises a table top or platform 20 and a frame 30 for supporting the table top 20 above a predetermined surface, such as a floor, dock, boat or truck bed. The table top 20 provides a surface for supporting and cleaning fish and/or game that preferably tilts backward or may be tilted backward for automatically draining water and debris backward off the table top 20. The table top 20 is preferably slidably mounted to and removable from the frame 30, as shown in FIG. 6. The table 10 includes grooves 55 for receiving the table top 20. The grooves 55 are preferably defined by the side panel's table top securing tabs 54 and the side braces 34 and 36, respectively. With reference to FIGS. 6 and 13, the securing tabs 54 project longitudinally outward from the inner surface of the side panels 50 and are substantially parallel with the frame's 30 side braces 34 and 36, respectively, when the side panels 50 are secured to the frame 30. The frame 30 is fixedly secured to the legs 24 and 26, which elevates and supports the table top 20 above a ground or floor-like surface. In an alternative embodiment, the frame 30 may be rotatably connected to the front legs 26 for pivoting about a pin and securely fastened to front legs 24, which slidably and lockably reside in sleeves, such as sleeves 1 shown in FIGS. 17A-17C. The back retaining panel 40 is securely mounted or mountable to the back edge of the table top frame 30, preferably using commonly available fasteners 45 and 57 as shown in FIGS. 1-6. The back retaining panel 40 includes vents 44 to allow water and debris to run off the back of the table top 20 and fastener apertures 42 for facilitating the mounting of the back retaining panel 40 to the table top frame 30. The back retaining panel 40 may be removable. The side retaining panels 50 preferably comprise side boards that are removably mounted to the table top frame side braces 34, 36 in a manner that directs water flow and debris toward the back of the table top 20. Gaps 55 may be defined at the comers between the side 50 and back 40 panels to further allow water and debris to run off the table top 20. The side panels 50 may be removed for accommodating larger catch and to facilitate removal for other purposes. The side panels 50 may also vary in size depending on the catch and/or the desire to adjust the placement of the spraying assembly. With reference to FIGS. 1 and 12, the adjustable spraying assembly 60 is rotatably attached to the side panels 50 via apertures 56. The adjustable spraying assembly 64 is rotatably attached to the side panels 50 to provide a means for spraying water onto the table top at a plurality of angels or from a plurality of directions. Although the instant invention 10 is primarily described in reference to fish, it may be used for cleaning game or other catch.

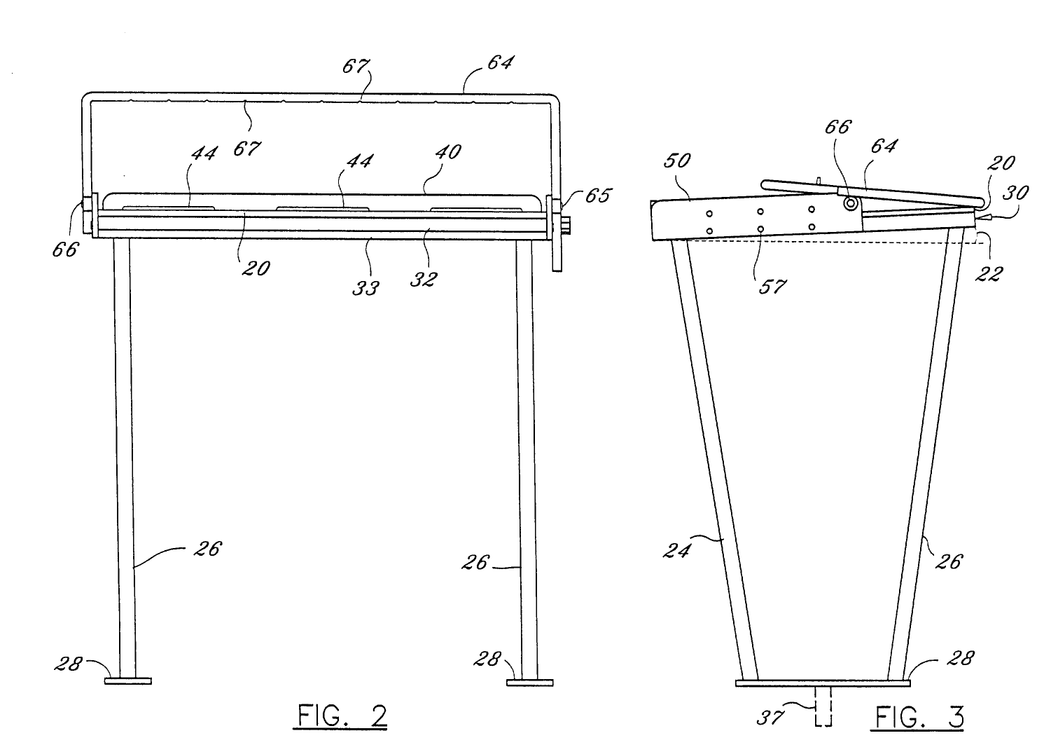

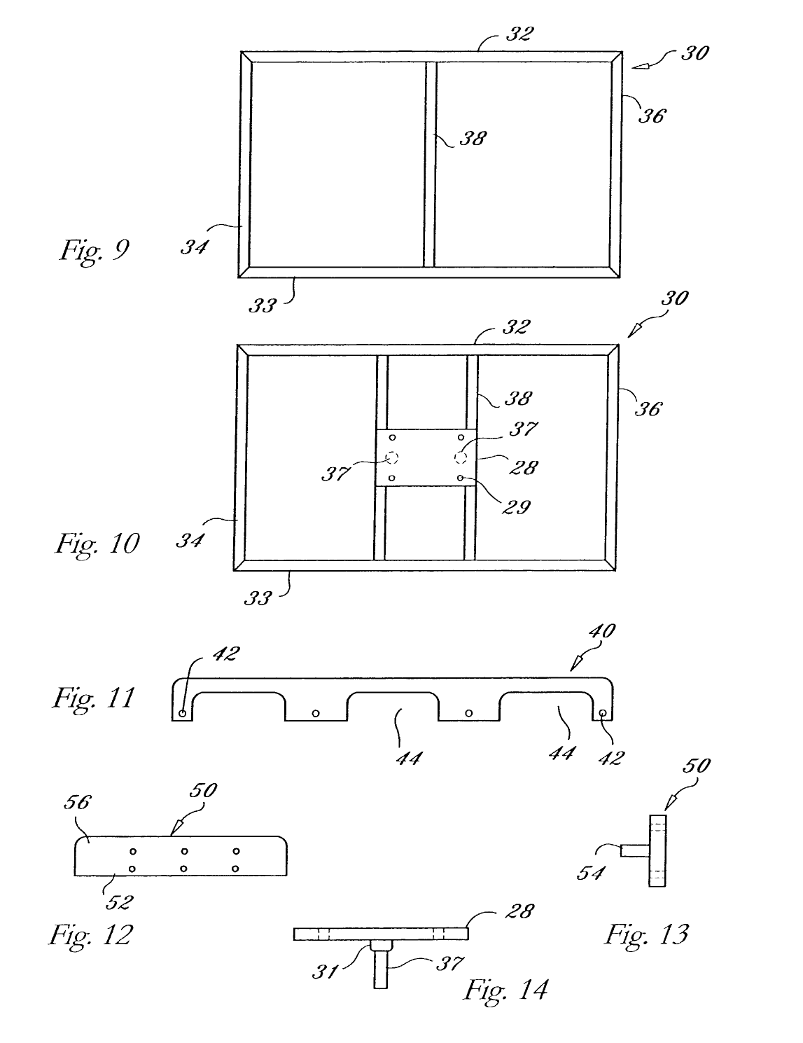

Referring to FIGS. 2-8, the table top frame 30 is secured to legs 24 and 26 and pitched at an angle 22 so that the back edge is lower than the front edge. This causes water and debris to wash away from the user toward the back of the table top 20. The table top assembly 20, 30 may be fixed at one angle 22 or be adjustable to other angles 22, as noted above with reference to an alternative embodiment. The table top 20 comprises a durable, water-safe and cut-safe properly dimensioned slab of material that facilitates cleaning off debris, bacteria and odors and cutting with sharp instruments, such as knives. The table top 20 material may comprise an acrylic resins, high density Polyethylene, Corian® or other comparable material known in the art. It may further be include a textured matte finish solid surface. The table top 20 is preferably approximately ¼ inch to ¾ inch in thickness. The table top 20 may also comprise a substrate having approximately 1/8 inch thick surface mounting offering substantially the same durability as the preferred table top 20. With reference to FIG. 9, the table top frame 30 comprises a substantially rectangular assembly formed by front and rear braces 32, 33 side braces 34, 36, and at least one cross-member brace 38. The braces 32-38 are preferably hollow for reduced manufacturing costs and substantially rectangular or square in cross section for enhanced stability in supporting the table top 20. The table top 20 is removably mounted over the frame 30, as noted above. The frame 30 is supported and elevated by a set of front and rear legs 24, 26 that preferably taper inward from top to bottom toward a set of corresponding bases 28, resulting in minimum obstruction to the user and people passing by the table 10. The table top legs may terminate toward a plurality of bases or a single base 28, as depicted in FIGS. 1, 6 and 10. With reference to FIG. 10, the table top frame for an alternative embodiment includes a plurality of cross braces 38 and may also include a single platform base 29. In the preferred embodiment, as shown in FIG. 1, each base 28 may contain holes 29 to allow for insertion of screws, bolts or nails to securely mount the fillet table securely to a floor or dock. In an alternative embodiment, the bases 28 may have a plurality of mounting rods 37 depending therefrom adapted for insertion in corresponding sleeves 1.

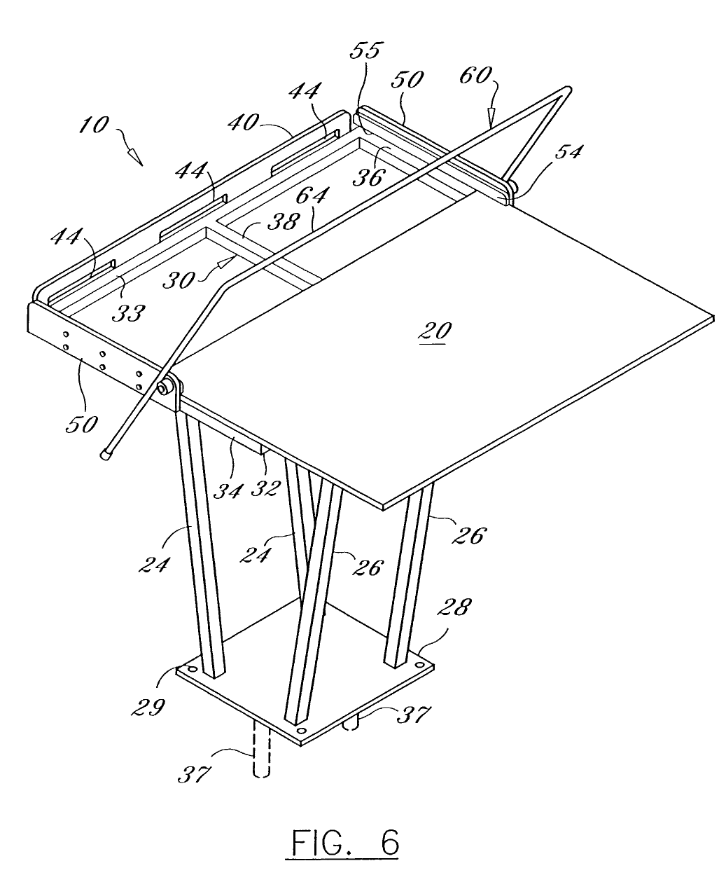

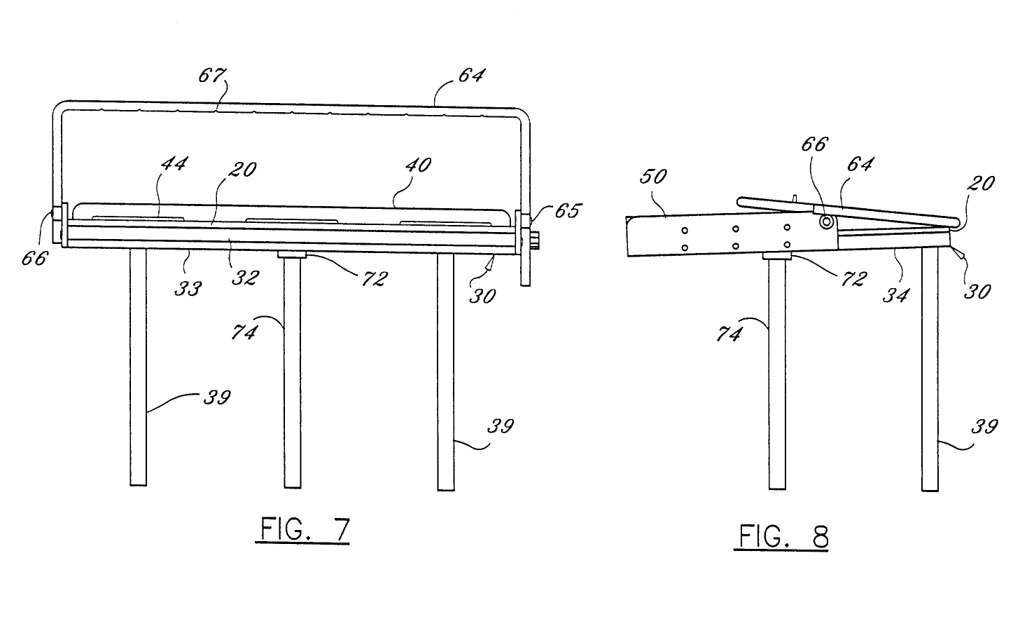

With reference to FIGS. 7, 8, 16 and 17A-C, the table 10 of the instant invention may be adapted for mounting to fishing rod holders or truck bed mounting posts. Referring to FIGS. 7 and 8, the alternative embodiment replaces legs 24 and 26 with at least one front leg 39 and a mounting assembly 70, which are both affixed to corresponding cross-member braces 38 and facilitate mounting the table 10 in a boat or truck bed. The mounting assembly 70 comprises a mounting post 74 adapted for sliding in a sleeve 1 secured in a boat or truck bed, U-joint 72, and pin or fastener 71, as shown in FIGS. 17A-17C. The mounting post 74 depends downward from a bottom plate 73 defined by the U-joint 72. In the first embodiment, the mounting post 74 depends substantially vertically and the U-joint 72 is pivotally attached to a cross-member brace 38 by pin or fastener 71 to achieve the desired tilt of the table top assembly 20, 30. The bottom plate 73 limits the amount of rotation that the table top assembly 20, 30 can realize, wherein the cross member brace 38 prevents rotation past the bottom plate 73. It should be noted that the U-joint 72 may be fixedly secured to the cross brace 38 in a manner that achieves the desired tilt of the table top assembly 20, 30. With reference to FIG. 17B, in a first alternative embodiment of the mounting assembly 70′, the U-joint 72′ is preferably fixed to the U-joint bottom plate 73′ at a first angle calculated to accommodate the desired tilt angle of the table top assembly 20, 30 while corresponding to fishing rod holder sleeves that are positioned at approximately thirty degrees. With reference to FIG. 17C, in a second alternative embodiment of the mounting assembly 70″, the U-joint 72″ is preferably fixed to the U-joint bottom plate 73″ at a second angle calculated to accommodate the desired tilt angle of the table top assembly 20, 30 while corresponding to fishing rod holder sleeves that are positioned at approximately sixty degrees.

With reference to FIG. 11, the preferred back panel 40 is shown. The back panel 40 helps keep fish from slipping off the table top 20. The back panel 40 attaches to the back brace 32 via a series of screws or fasteners that insert in apertures 42 to the back edge of the table top 20. The back panel 40 preferably contains one or more vents 44, which are fully defined when the back panel 40 is secured to the back brace 33, to allow water and debris to wash off the back of the table 10 through the apertures 44.

With reference to FIGS. 12 and 13, a typical side panel 50 is shown. The side panels 50 have a plurality of apertures 52 for accommodating fasteners used in securing the side panels to the table 20 side edges and/or frame. The side panels 50 are attachable to the table top frame's 30 side braces, 34 and 36, respectively, to contain the catch on the table top 20 and to help direct the flow of water and debris toward the back of the fillet table 10. The side panels 50 may be removed to allow for larger fish. The side panels 50 include table top securing tabs 54 projecting outward from the side panels and having a distance there between that facilitates a modular fit with the table top 20 and table top frame 30.

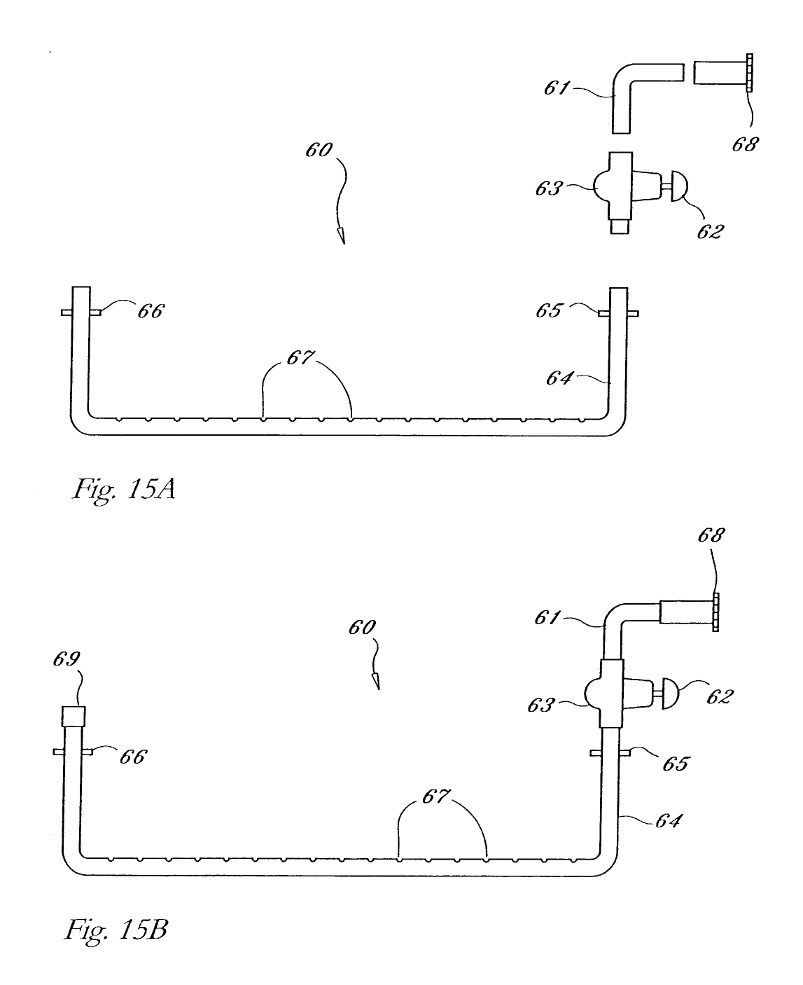

Referring to FIGS. 15a and 15b, the adjustable spraying assembly 60 comprises a U-shaped rod 64 having a plurality of perforations 67, an on/off valve assembly 62, 63, an elbow joint 61 and a water supply connector 68 attached to the elbow pipe joint 61. The U-shaped rod 64 preferably comprises a single piece of PVC bent near each end a predetermined distance from the rod's ends. The on/off valve assembly 62, 63 preferably comprises a ball valve 63 that provides and deprives access to a water supply. The inside end of the elbow pipe joint 61 is attached to the ball valve 63 that starts, stops and controls the flow of water via a handle 62. The other end of the ball valve 63 is attached to the U-shaped hollow rod 64. A series of holes or perforations 67 are defined in the rod 64 and at least along the center portion of the rod to allow water to exit the rod 64. The free end of the rod 64 is sealed with a plug 69 to contain the water and force it out the perforations 67. Pivot pins 65 and 66 are welded under the shorter ends of the rod 64. The pins 65, 66 plug into holes 56 on each of the side panels 50, allowing the rod 64 to pivot freely. After or during the cleaning or filleting fish, the user pivots the rod 67 into an upward position over the table top 20 and turns the handle 62 to open the ball valve 63, thus allowing water to enter the rod from a hose. The water sprays out of the holes 67 onto the table top 20. Water and debris wash toward the lower end of the table top 20 away from the user and exits the cleaning table 10 through rear panel vents 44 and gaps in the comers between the rear panel 40 and side panels 50. The spray assembly 60 is preferably rotatably/pivotably mounted to the side panels, which allows the spraying assembly 60 to be removed along with the side panels 50. Alternatively, the spray assembly 60 may be rotatably/pivotably mounted to the table top 20 at, to or near the side edges 20b, and preferably proximal the front edge 20a. The rod 64, plug 69, ball valve 63, elbow joint 61 and/or water supply connector 68 preferably comprises fitted ends that mate and may be sealed using a water proof adhesive. Alternatively, threaded fittings may be use. The components of the spraying assembly 60 are preferably made from PVC to the extent possible.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A table apparatus for cleaning and filleting fish and game, said table comprising:
a table top comprising a top surface, front side, back side and opposing sides between said front and back sides, said back side being lower than said front side such that said top surface declines from said front side to said back side;
leg means, connected to said table top, for supporting and elevating said table top; and
a back plate mountable to said table top along said back side for retaining fish and game thereon, said back plate having at least one vent for allowing water and debris to flow therethrough.

2. A table as recited in claim l, further comprising:
adjustable spray means, pivotally mounted to said table top, for receiving and spraying water from a water source on said top platform.

3. A table as recited in claim 2, wherein said adjustable spray means further comprises:
a substantially u-shaped, hollow rod having a first free end, a second free end and a plurality of apertures therebetween for passing the water, said rod being in pivoting communication with said top platform;
means, in mechanical engagement with said first free end, for receiving water through said first free end; and
flow control means, in mechanical engagement with said rod, for controlling the rate of flow of water through said rod.

4. A table as recited in claim 1, wherein said table top comprises:
a frame having a front brace, a rear brace and opposing side braces;
a platform corresponding to the dimensions of said frame; and
platform mounting means, being partially defined by said frame, for slidably mounting said platform to said frame.

5. A table as recited in claim 1, further comprising:
at least one side plate removably mountable to each of said opposing sides of said table top proximal and along at least a portion of said opposing side edges for retaining fish or game on said top platform.

6. A table as recited in claim 5, wherein said table top comprises:
a frame having a front brace, a rear brace and opposing side braces;
a platform corresponding to the dimensions of said frame; and
platform mounting means for slidably mounting said platform to said frame, said platform mounting means comprising tabs that project outward from said side panels and cooperate with said opposing side braces to define a groove between said tabs and said opposing side braces when said side plates are mounted to said table top.

7. A table as recited in claim 5, further comprising:
adjustable spray means, pivotably mounted to said side plates, for receiving and spraying water received from a water source on said top platform.

8. A table as recited in claim 7, wherein said adjustable spray means further comprises:
a substantially u-shaped, hollow rod having a first free end, a second free end and a plurality of apertures therebetween for passing the water, said rod being in pivoting communication with said table top;
means, in mechanical engagement with said first free end, for receiving water through said first free end; and
flow control means, in mechanical engagement with said rod, for controlling the rate of flow of water through said rod.

9. A table as recited in claim 1, wherein said leg means comprises a plurality of posts fixed at one end to said table top and tapering inward from said table top downward toward an opposite end for providing clearance below said front side.

10. A table as recited in claim 9, wherein said opposite ends of said posts are terminated with at least one base plate adapted for securing to a flat surface.

11. A table as recited in claim 1, wherein said leg means comprises:
means, connected to said table top, for mounting said table in a preexisting sleeve.

12. A table as recited in claim 11, wherein said means for mounting comprises:
at least one post depending downward from said table top and being adapted for insertion in a preexisting sleeve, said post depending at an angle that accommodates said decline of said top surface.

13. A table as recited in claim 12, wherein said means for mounting further comprises:
a base adapted for pivoting attachment to a bottom surface of said table top, said post depending downward from said base.

14. A table as recited in claim 4, wherein said leg means comprises:
means, connected to said frame, for mounting said table in a preexisting sleeve.

15. A table as recited in claim 14, wherein said means for mounting comprises:
at least one cross brace bridging said front brace and said back brace;
at least one post depending downward from said cross brace and being adapted for insertion in a preexisting sleeve, said post depending at an angle that accommodates said decline of said top surface.

16. A table as recited in claim 15, wherein said means for mounting further comprises:
a base adapted for pivoting attachment to said cross brace, said post depending downward from said base.

17. A table as recited in claim 16, wherein said means for mounting further comprises:
at least one auxiliary brace depending downward from said frame for cooperating with said post in supporting and elevating said table top.

18. A table as recited in claim 1, wherein said leg means comprises:
means for adjusting the height of said back side relative to said front side.

19. A table as recited in claim 6, wherein said platform comprises a material that is water safe and adapted for cutting with sharp instruments.

20. A table apparatus for cleaning and filleting fish and game, said table comprising:
a table top comprising a top surface, front side, back side and opposing sides between said front and back sides, said back side being lower than said front side such that said top surface declines from said front side to said back side;
leg means in mechanical engagement with said top platform for supporting and elevating said table top;
a back plate mountable to said table top along said back side for retaining fish and game thereon, said back plate having at least one vent for allowing water and debris to flow therethrough; and
adjustable spray means, in mechanical and pivoting communication with said table top platform, for receiving and spraying received water on said top platform.

21. A table as recited in claim 20, wherein said adjustable spray means further comprises:
a substantially u-shaped, hollow rod having a first free end, a second free end and a plurality of apertures therebetween for passing the water, said rod being capable of pivoting in relation to said top platform;
means, in mechanical engagement with said first free end, for receiving water through said first free end; and
flow control means, in mechanical engagement with said rod, for controlling the rate of flow of water through said rod.

22. A table as recited in claim 20, further comprising:
opposing side plates removably mountable to said table top proximal and along at least a portion of said opposing sides for retaining fish or game on said top platform.

23. A table as recited in claim 22, wherein said back plate and said opposing side plates define a gap between opposing ends of said back plate and corresponding ends of said side plates for venting water and debris without passing fish or game.

24. A table as recited in claim 23, wherein said leg means comprises a plurality of posts fixed at one to said table top and tapering inward toward an opposite end.

25. A table as recited in claim 20, wherein said leg means comprises:
means for mounting said table in a preexisting sleeve.
